(19) United States
(12) Patent Application Publication
(10) Pub. No.: US 2018/0222299 A1
(43) Pub. Date: Aug. 9, 2018

(54) REMOVABLE VEHICLE ROOF

(71) Applicant: Gabrielle Volpicelli, Upton, MA (US)

(72) Inventor: Gabrielle Volpicelli, Upton, MA (US)

(21) Appl. No.: 15/892,031

(22) Filed: Feb. 8, 2018

Related U.S. Application Data
(63) Continuation-in-part of application No. 29/593,401, filed on Feb. 8, 2017, now Pat. No. D817255.
(60) Provisional application No. 62/456,392, filed on Feb. 8, 2017.

(51) Int. Cl. B60J 7/11; B60J 7/16; B60J 10/90

(52) U.S. Cl. CPC B60J 7/11; B60J 10/90; B60J 7/1642

(57) ABSTRACT

A method and apparatus for a removable vehicle roof. A vehicle roof for a vehicle includes a translucent outer body capable of spanning the width of a vehicle, the outer body formed by the coupling of a left panel and a right panel along a central axis, the left panel having a curved left outer edge and the right panel having a curved right outer edge, a left inner support frame attached to the left panel and having left brackets and left bumpers, and a right inner support frame attached to the right panel and right brackets and right bumpers, the left brackets and the right brackets configured to affix the vehicle roof to the top of the

[symbol]

### CROSS REFERENCE TO RELATED APPLICATIONS

This application claims benefit from U.S. Provisional Patent Application Ser. No. 62/456,392, filed Feb. 8, 2017, and is a continuation-in-part of U.S. application Ser. No. 29/593,401, filed Feb. 8, 2017, which are incorporated by reference in their entireties.

### STATEMENT REGARDING GOVERNMENT INTEREST

None.

### BACKGROUND OF THE INVENTION

The invention generally relates to vehicles, and more particularly to a removable vehicle roof.

Traveling in a vehicle surrounded by solid walls can often feel congested. Some vehicles are designed to help relieve this feeling. For examples, some vehicles are designed with sun roofs to let in additional light. However, sun roofs are limited in that they only allow light to pass in a small area within the roof. Alternatively, vehicles with convertible roofs are designed to completely expose a traveler to the outside elements, including rain, wind, light, and more. However, most travelers prefer not to be completely exposed to all elements at all times.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus for a removable vehicle roof.

In an aspect, the invention features a vehicle roof for a vehicle including a translucent outer body capable of spanning the width of a vehicle, the outer body formed by the coupling of a left panel and a right panel along a central axis, the left panel having a curved left outer edge and the right panel having a curved right outer edge, a left inner support frame attached to the left panel and having left brackets and left bumpers, and a right inner support frame attached to the right panel and right brackets and right bumpers, the left brackets and the right brackets configured to affix the vehicle roof to the top of the vehicle.

In another aspect, the invention features a method of making a removable translucent vehicle roof for a vehicle including forming a translucent left panel with a detachable left inner support frame having left brackets and left bumpers, forming a translucent right panel with a detachable right inner support frame having right brackets and right bumpers, and hermetically sealing the left panel to the right panel using a latching system.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a perspective view of vehicle having an exemplary removable roof.

FIG. 2 is a perspective view of a removable vehicle roof attached to a vehicle in accordance with the subject technology.

FIG. 3 is an exploded view and a bottom perspective view of a vehicle roof in accordance with the subject technology.

FIG. 4 is a bottom view of a series of inner support frames in accordance with the subject technology.

FIG. 5A is a bottom perspective view of a right panel in accordance with the subject technology.

FIG. 5B is a front perspective view of a right panel in accordance with the subject technology.

FIG. 6A is a bottom perspective view of inner support brackets and a panel in accordance with the subject technology.

FIG. 6B is a bottom perspective view of inner support brackets attached to a panel in accordance with the subject technology.

FIG. 7 is a top perspective view of a vehicle roof in accordance with the subject technology.

FIG. 8 is a bottom perspective view of the vehicle roof in accordance with the subject technology.

FIG. 9 is a front view of the vehicle roof in accordance with the subject technology.

FIG. 10 is a rear view of the vehicle roof in accordance with the subject technology.

FIG. 11 is a left side view of the vehicle roof in accordance with the subject technology.

FIG. 12 is a top view of the vehicle roof in accordance with the subject technology.

FIG. 13 is a bottom view of the vehicle roof in accordance with the subject technology.

FIG. 14 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

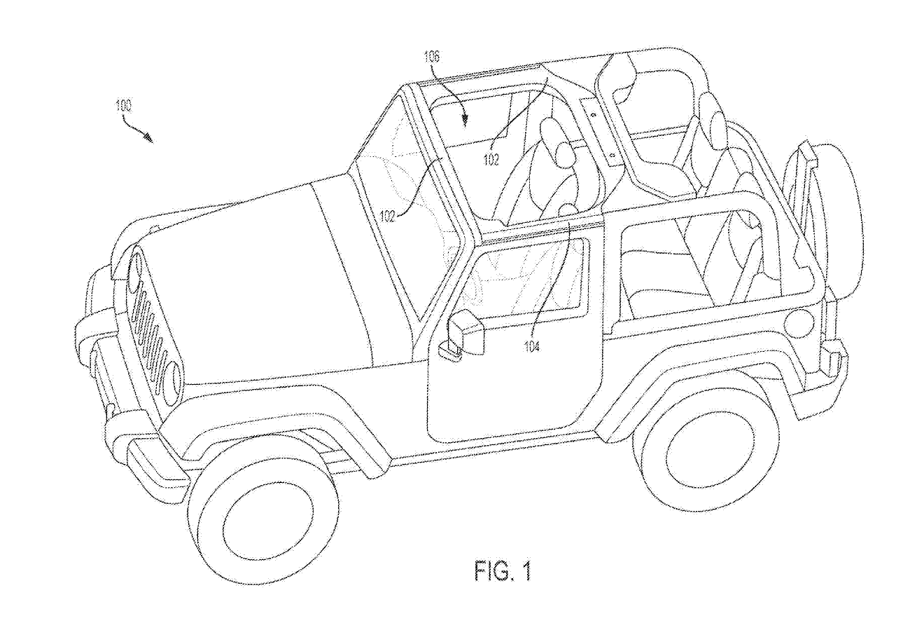

In FIG. 1, a vehicle with no roof is shown generally at 100. While no roof is currently attached to the vehicle 100, the vehicle 100 has a support structure 102 that enables a roof to be affixed to the top of the vehicle 100. Outer support members 104 run along the outside of the support structure 102 along the sides of the vehicle 100. When no roof is affixed to the support structure 102, a gap 106 is formed within the vehicle support structure 102. Generally, vehicles such as the vehicle 100 shown will be sold with a solid detachable panel (not shown) affixed to cover the gap 106. This panel is generally formed from a solid metal, much like the rest of the exterior of the vehicle 100, or a canvas.

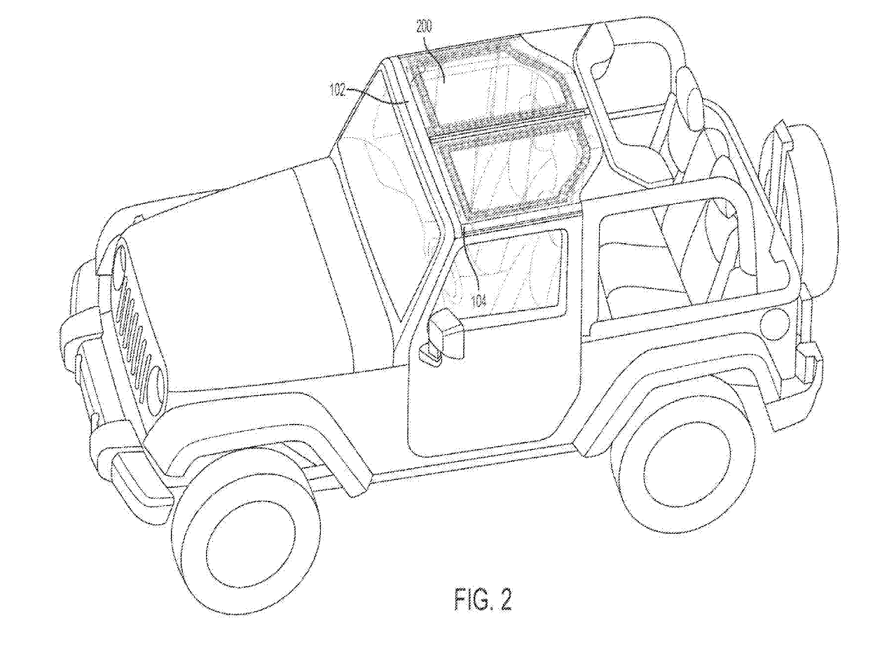

In FIG. 2, a vehicle 100 with an exemplary removable translucent roof in accordance with the subject technology is shown generally at 200. The roof 200 is firmly affixed to the support structure 102 of the vehicle 100 as discussed more fully herein. Once the roof 200 is attached to the vehicle 100, it prevents elements like rain and wind from entering the top of the vehicle 100 while still providing a look and feel of an open vehicle top. For example, the roof 200 enables people inside the vehicle 100 to see through the roof 200 and also enables light to pass through the roof 200 into the vehicle 100.

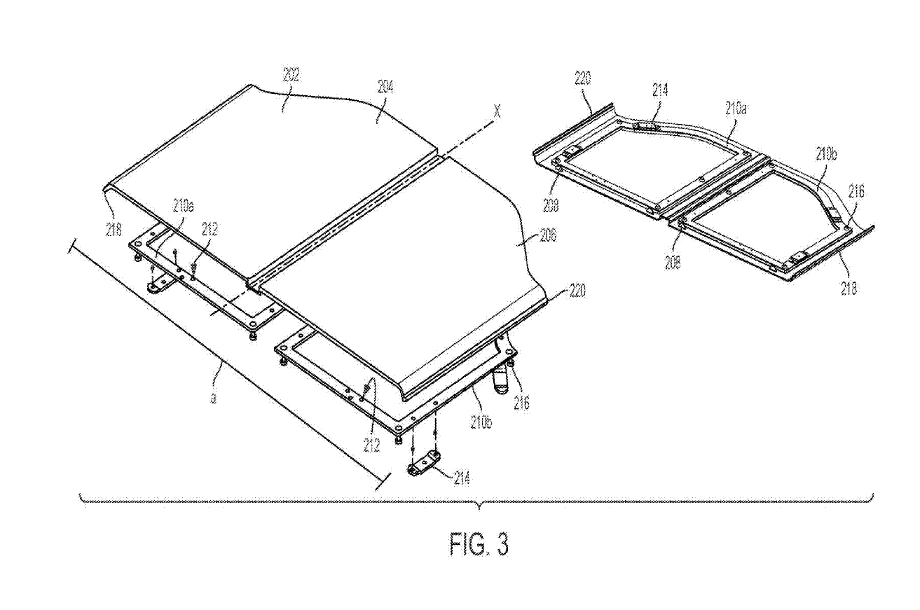

In FIG. 3, an exploded view of the vehicle roof is shown generally at 200. The roof 200 has an outer body 202 which has a width “a” that enables it to span a width of a vehicle 100. The outer body 202 is formed by a left panel 204 and a right panel 206 which are coupled along a central axis “x.” The panels 204, 206 are translucent, thus when coupled together to form the outer body 202, the outer body 202 is translucent. In different embodiments, translucent can mean a range of various tints. For example, translucent may mean that the outer body 202 is completely clear, enabling all light to pass through and complete visibility through the outer body 202. Alternatively, the outer body 202 may be tinted black or tinted with a color to various degrees. A heavily tinted outer body 202 may enable very little light to pass through and very little visibility, while a lightly tinted outer body 202 may enable most light to pass through and almost unimpeded visibility. Moreover, in some embodiments, a customized tint (color) may be designed within the glass itself.

A number of tabs 208 extend downward from the outer body 202. The tabs 208 enable the vehicle roof 200 to rest comfortably within the support structure 102 of the vehicle 100, keeping the vehicle roof 200 in uniform contact with the support structure 102 until the vehicle roof 200 can be coupled more securely to the vehicle 100, as fully described below.

A left inner frame 210a and right inner frame 210b are attached to the left and right panels 204, 206, respectively. The frames 210 provide structural support for the outer body 202 and also help the vehicle roof 200 be attached to, and rest upon, the support structure 102 and outside support members 104 of a vehicle 100. For example, multiple brackets 214 are coupled to the underside of the frames 210. The multiple brackets 214 are normally of a universal size that enables them to conjoin with respective brackets on a typical vehicle support structure 102. The brackets 214 do not permanently attach the vehicle roof 200 to the vehicle 100, but rather, are operable to later remove the vehicle roof 200 should a user so desire. Further, multiple cushioned bumpers 216 attach to the underside of the inner frames 210. The multiple cushioned bumpers 216 provide a cushioned medium between the frames 210 and the support structure 102 of the vehicle 100 to enable the frames 210, and thus the outer body 202, to rest on the top support structure 102 without damaging any parts. The multiple cushioned bumpers 216 have a vibration dampening effect and also reduce the noise that would otherwise result from the striking of the frames 210 and/or outer body 202 against the support structure 102 as the vehicle 100 travels. The outer edges of the panels also have a curved left outer edge 218 and curved right outer edge 220, respectively, which are distal to the central axis “x.” The curved outer edges 218, 220 enable the outer body 202 to sit comfortably on the outer support members 104 of a vehicle support structure 102.

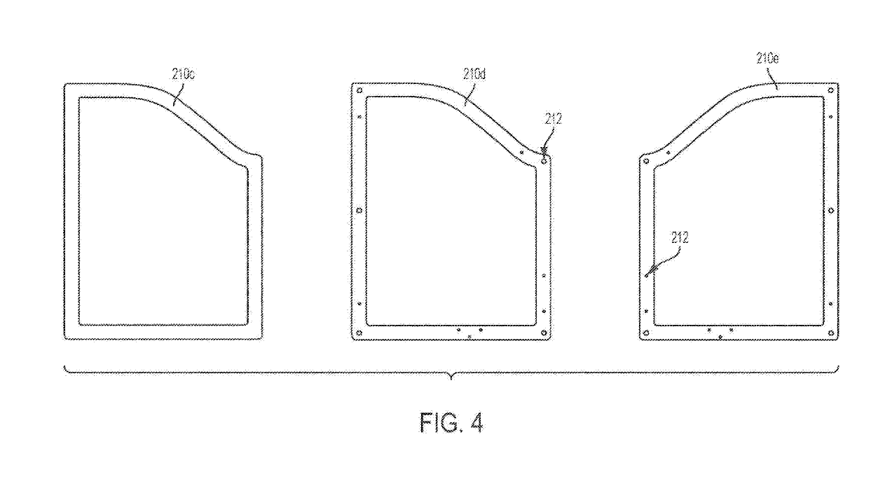

In FIG. 4, inner frames 210 in accordance with the subject technology are illustrated. Before an inner frame 210 is ready to be implemented with the subject technology, a structural material, such as aluminum, steel, carbon fiber, and so forth, is formed into substantially the shape of a frame 210c. Threaded holes 212 for riveted brackets, bumpers, and closures are then added to the frame 210c to create frames for a right or left panel 210d, 210e. The frames 210 can be used on either the left or right side of the vehicle roof, depending on which whether the each frame 210 is attached to a left or right panel 204, 206. The frames 210d, 210e are mirror images of one another and can be flipped to attach to either panel 204, 206.

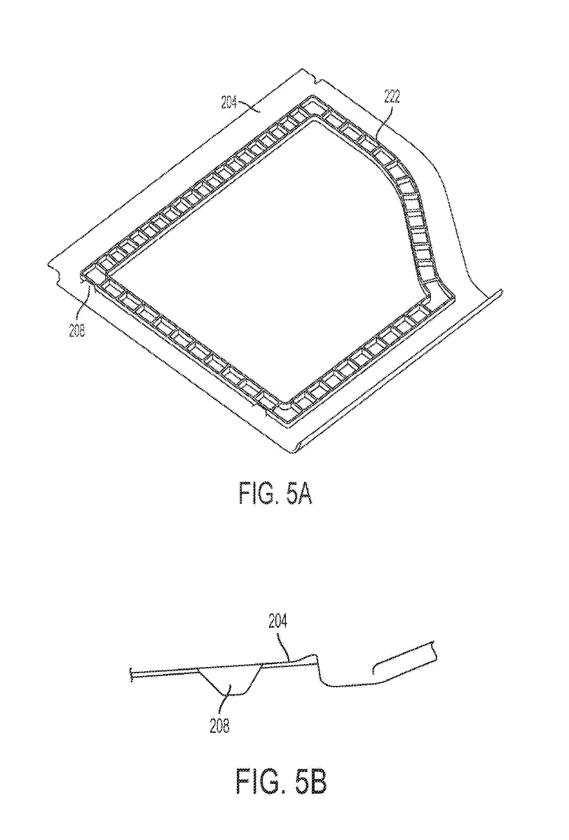

In FIGS. 5A and 5B, views of a left panel 204 in accordance with the subject technology are shown. The right panel 206 is a mirror image of the left panel 204 and, in at least one embodiment, is otherwise substantially the same as the left panel 204. The left panel 204 is made predominately, or entirely, from a clear material, such as injection molded acrylic. The panel 204 has a ribbed underbelly 222 which provides structural strength to the panel 204 and enables it to join with a left inner frame 210a. Alternatively, the underbelly can be domed, or otherwise include supports to provide structural strength to the panel 204. The ribbed underbelly 222 can support the panel 204 at a height such that the vehicle roof 200 aligns with, or is just above, the support structure 102 of the vehicle 100.

In other embodiments, the left panel 204 can be formed by sealing individual panes (not individually shown here) together. The panes are formed from a clear plastic, glass, or the light, such that they enable light to pass through and/or are see-through. The panes may be sealed together using an insulated glazing technique to improve dampening and create an internal thermal system within the vehicle 100 when the vehicle roof 200 is in use.

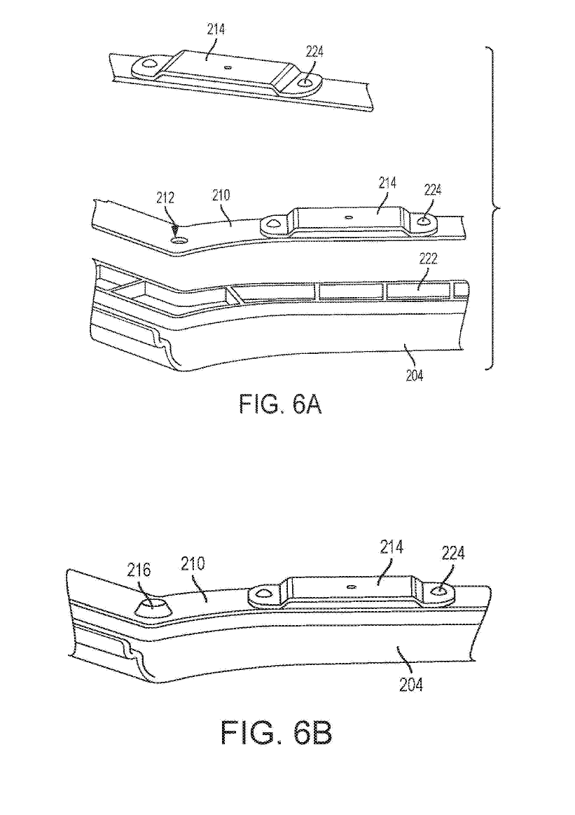

In FIGS. 6A and 6B, a panel 204 is shown being connected to an inner support frame 210. Mounting brackets 214 are attached to the underside of the support frame 210 by screws 224 which pass through the mounting bracket 214 and into the frame 210. The inner frame 210 can then be attached to the panel 204 through various techniques. For example, an acrylic adhesive can be applied to the molded portion of the panel 204 and the topside of the frame 210 can then be placed against the adhesive to bond the frame 210 to the panel 204. Once the panel 204 is attached to the inner frame 210, bumpers 216 can snapped into the remaining holes 212 to provide a cushion between the finished vehicle roof 200 and the vehicle 100. When all the aforementioned components are firmly in place, fully formed left and right panels 204, 206 with respective right and left inner support frames 210 can be coupled together to form a complete vehicle roof 200. The vehicle roof 200 can then be removably attached to the support structure 102 of a vehicle 100, as described above.

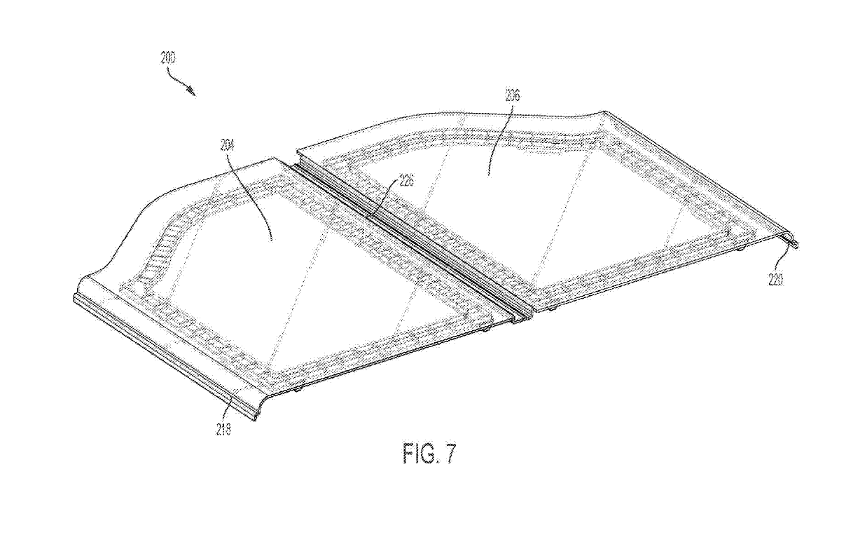

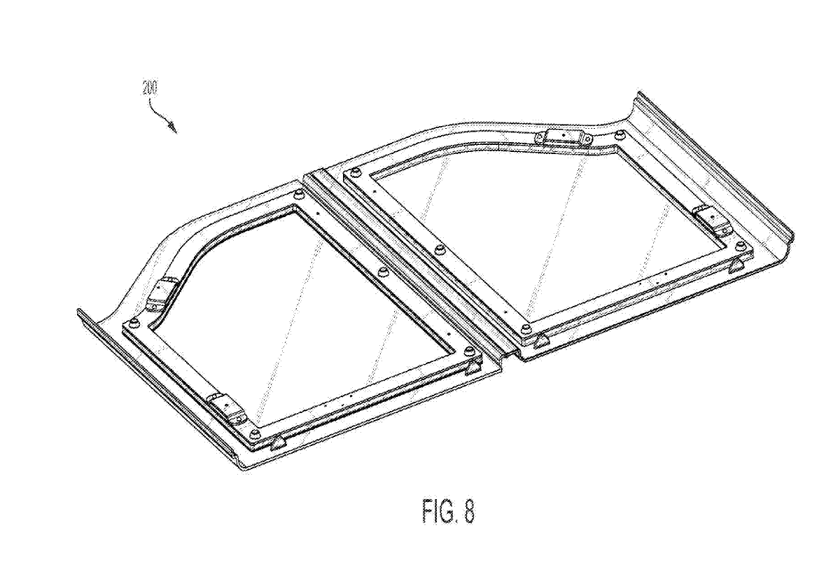

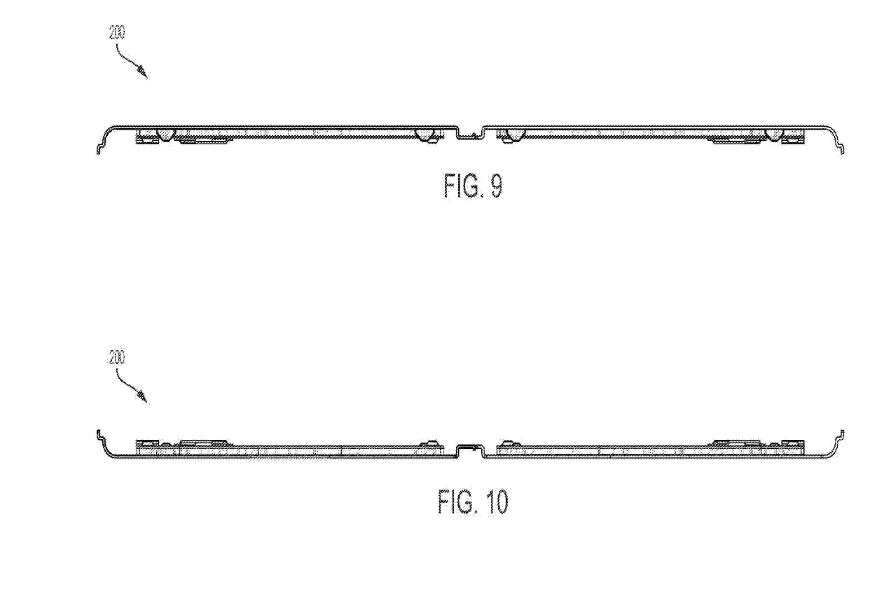

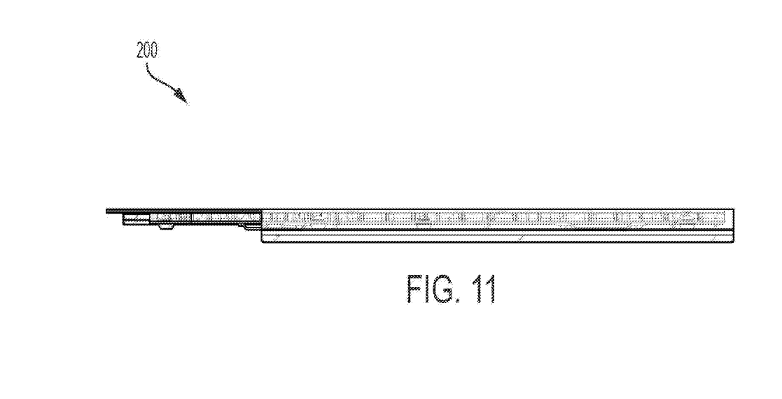

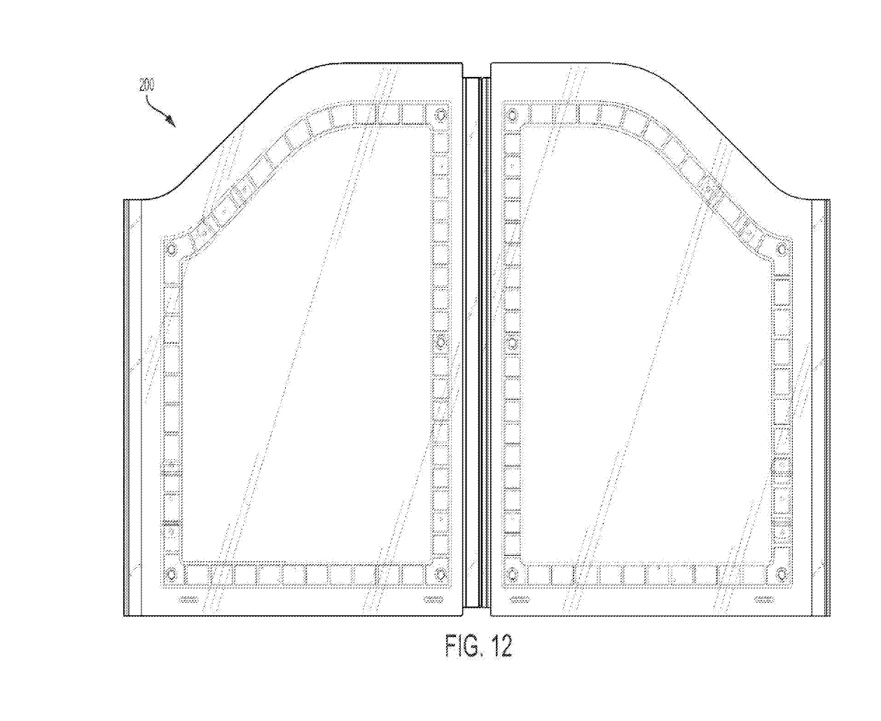

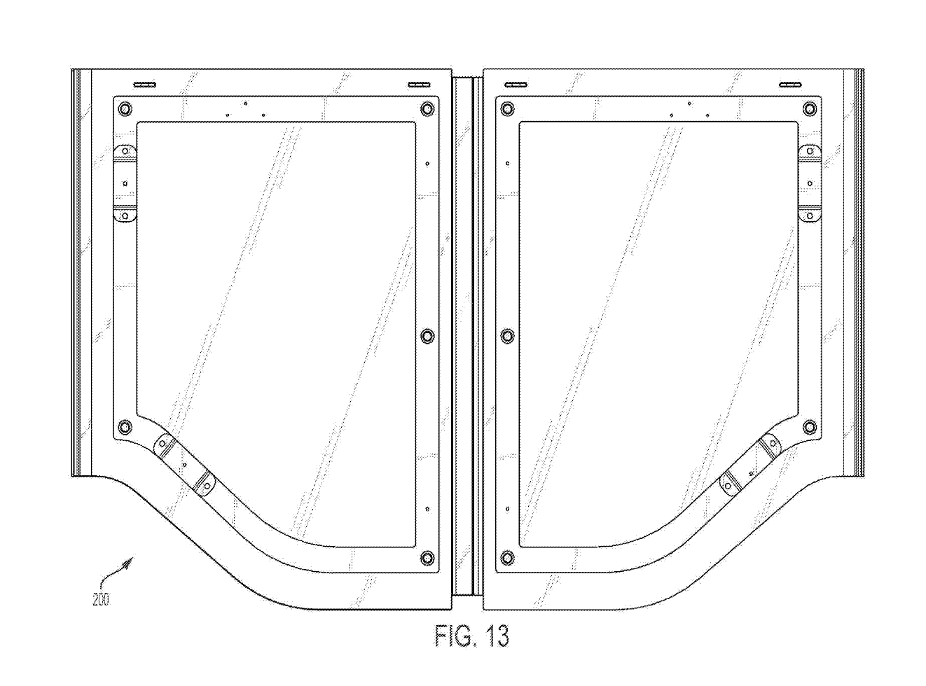

In FIGS. 7-13, views of a fully assembled vehicle roof 200 for a vehicle 100 in accordance with the subject technology are shown. As shown, the left and right panels 204, 206 are coupled together at a central location 226 to form the outer body 202. The vehicle roof 200, being made of a transparent or translucent material, allows light to pass through and as shown is substantially see through. As described above, the brackets 214 enable the vehicle roof 200 to be removably latched onto the support structure 102 of a vehicle 100.

Referring again to FIG. 2, the fully formed removable vehicle roof 200 protects a driver and front passenger from the outside environment when affixed to the vehicle 100. Unlike a traditional roof, the driver and passenger are still able to see outside the vehicle through the vehicle roof. The ribs 222 of the right and left panels 204, 206 provide structural support for the panels 204, 206 and the outer body 202 as the vehicle travels over the road. The vehicle roof 200 is affixed directly against the vehicle 100, via the various components described above, such as, for example, pins, closures 214, rubber bumpers 216 and so forth.

In one embodiment, lock and release latches are placed within/on the base frame that match into a manufactured slot in the translucent top enabling the immediate removal of just the translucent tops allowing for an interchangeable design (i.e., the ability to mix and match top designs and color, and so forth) and allowing the base frame to stay latched in to the vehicle frame if desired.

These latch and release hinges can be designed to hold the translucent top in place but allow it to be extended upward and back (towards the rear of the vehicle) and lock into location, much like a sunroof, allowing no immediate removal of the panels.

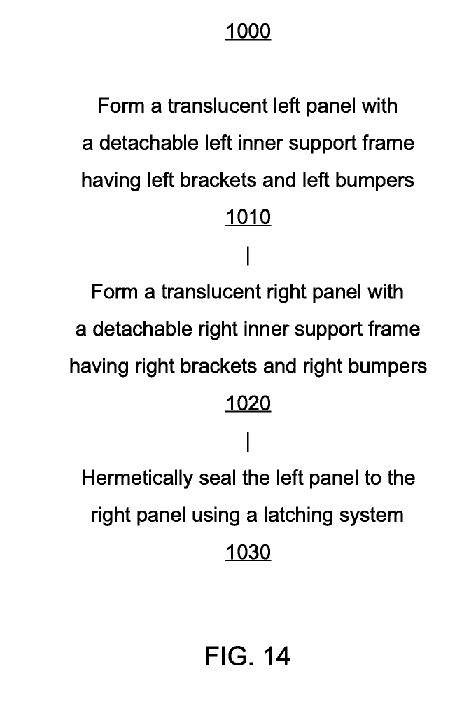

As shown in FIG. 14, a process 1000 of making a removable translucent vehicle roof for a vehicle includes forming (1010) a translucent left panel with a detachable left inner support frame having left brackets and a left bumpers. In embodiments, the translucent left panel may have a ribbed underbelly. In embodiments, the translucent left panel may be tinted. In an embodiment, the translucent left panel is tinted black.

Process 1000 forms (1020) a translucent right panel with a detachable right inner support frame having right brackets and a right bumpers. In embodiments, the translucent right panel may have a ribbed underbelly. In embodiments, the translucent right panel may be tinted. In an embodiment, the translucent right panel is tinted black.

Process 1000 hermetically seals (1030) the left panel to the right panel using a latching system. In embodiments, the latching system includes insulated glazing.

In embodiments, the hermetically sealed left panel and right panel are rested within a support structure of a vehicle. In embodiments, the hermetically sealed left panel and right panel removably secured within are the support structure of the vehicle by engaging the left and right brackets and the left and right bumpers with corresponding mounting brackets integral to the support structure of the vehicle.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A vehicle roof for a vehicle comprising:
a translucent outer body capable of spanning the width of a vehicle, the outer body formed by the coupling of a left panel and a right panel along a central axis, the left panel having a curved left outer edge and the right panel having a curved right outer edge;
a left inner support frame attached to the left panel and having left brackets and left bumpers; and
a right inner support frame attached to the right panel and having right brackets and right bumpers, the left brackets and the right brackets configured to affix the vehicle roof to the top of the vehicle.

2. The vehicle roof of claim 1 wherein the translucent outer body is tinted.

3. The vehicle roof of claim 2 wherein the translucent outer body is tinted by applying a resin or interlayer to the outer body.

4. The vehicle roof of claim 1 wherein:
the left panel is formed by left panes sealed together; and
the right panel is formed by right panes sealed together.

5. The vehicle roof of claim 4 wherein:
the left panes are sealed together by insulated glazing to improve dampening and create a left internal thermal system; and
the right panes are sealed together by insulated glazing to improve dampening and create a right internal thermal system.

6. The vehicle roof of claim 1 wherein:
the left panel includes a left ribbed inner support structure and the inner left frame is attached to the left panel by the left ribbed inner support structure; and
the right panel includes a right ribbed inner support structure and the inner right frame is attached to the right panel by the right ribbed inner support structure.

7. A method of making a removable translucent vehicle roof for a vehicle comprising:
forming a translucent left panel with a detachable left inner support frame having a left brackets and left bumpers;
forming a translucent right panel with a detachable right inner support frame having right brackets and right bumpers; and
hermetically sealing the left panel to the right panel using a latching system.

8. The method of claim 7 wherein the latching system comprises insulated glazing to enable dampening.

9. The method of claim 7 further comprising resting the hermetically sealed left panel and right panel within a support structure of a vehicle.

10. The method of claim 9 further comprising removably securing the hermetically sealed left panel and right panel within the support structure of the vehicle by engaging the left and right brackets and the left and right bumpers with corresponding mounting brackets integral to the support structure of the vehicle.

11. The method of claim 9 wherein the support structure includes cushioned bumpers to provide a cushioned medium.

12. The method of claim 7 wherein the translucent left panel has a ribbed underbelly.

13. The method of claim 12 wherein the translucent right panel has a ribbed underbelly.

14. The method of claim 7 wherein the translucent left panel and the translucent right panel are tinted.

15. The method of claim 14 wherein the translucent left panel and the translucent right panel are tinted black.
